(19) United States
(12) Patent Application Publication
(10) Pub. No.: US 2009/0239705 A1
(43) Pub. Date: Sep. 24, 2009

(54) CONTROL DEVICE AND CONTROL METHOD FOR VEHICLE

(75) Inventors: Masahiro Tawara, Toyota-shi (JP); Masayuki Tsujita, Okazaki-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/401,972

(22) Filed: Mar. 11, 2009

(30) Foreign Application Priority Data
Mar. 21, 2008 (JP) 2008-074140

(51) Int. Cl. F16H 61/14; F16H 47/06; G06F 17/00

(52) U.S. Cl. 477/38; 701/58

(57) ABSTRACT

By shifting a lock-up clutch of a torque converter from a released state into an engaged state on condition that a gear ratio of an input shaft of a CVT to an output shaft of the CVT is decreasing (upshift), a lock-up control at the time of an increase in vehicle speed is performed while the gear ratio is being changed in a stepped manner. Thus, it is possible to synchronize a decrease in engine rotational speed due to shifting with a decrease in engine rotational speed due to lock-up engagement. Hence, lock-up engagement may be performed so that the driver does not recognize a decrease in engine rotational speed due to the lock-up engagement and, as a result, it is possible to prevent driver's uncomfortable feeling.

### INCORPORATION BY REFERENCE

The disclosure of Japanese Patent Application No. 2008-074140 filed on Mar. 21, 2008 including the specification, drawings and abstract is incorporated herein by reference in its entirety.

### BACKGROUND OF THE INVENTION

1. Field of the Invention

The invention relates to a control device and control method for a vehicle equipped with a lock-up torque converter and a transmission.

2. Description of the Related Art

In recent years, automatic transmission (AT) vehicles (AT vehicles) that automate gear shiftings and clutch operations required for manual transmission (MT) vehicles (MT vehicles) have been increasing, and it is said that the percentage of AT vehicles exceeds 90 percent of commercially available vehicles.

The AT mechanism includes a torque converter and a transmission mechanism. The torque converter utilizes the flow of fluid, such as hydraulic oil (oil), to transmit power from a power source (engine or electric motor) to the shaft of the transmission mechanism. The transmission mechanism combines a plurality of gears to shift the gear ratio between the input rotational speed and the output rotational speed in a stepped manner and then outputs the power. Thus, the AT mechanism automatically shifts gears on the basis of an accelerator operation amount and a vehicle speed. In addition, the transmission mechanism includes a continuously variable transmission (CVT) that has no fixed gear ratios and steplessly sets gear ratios. Note that some CVTs may shift gears by changing gear ratios in a stepped manner.

For example, a CVT with a manual range (M range) has been suggested, which determines gears, such as first to sixth gears, and allows shifting into the gears by driver's manual operation (for example, see Japanese Patent Application Publication No. 11-20513 (JP-A-11-20513)). In addition, some CVTs not only allow manual shifting in the above manual range but also allow shifting by changing gear ratios in a stepped manner during running in automatic shift range (D range).

Note that in the specification, in the CVT, shifting by changing gear ratios in a stepped manner is called a step shift, and a change in gear ratio in a stepped manner is called a step change.

The CVTs mounted on vehicles, such as automobiles, include belt CVTs. The belt CVT includes a primary pulley that is driven by an engine, an output-side secondary pulley that is connected to driving wheels, and a power transmission element, such as a belt or a chain, that is wound around the primary pulley and the secondary pulley. The groove width of the primary pulley and the groove width of the secondary pulley are changed by hydraulic pressure to change the turning radii of the power transmission element around the primary pulley and the secondary pulley. Thus, the belt CVT is able to steplessly change gear ratios.

A control device for such a CVT automatically controls the gear ratio on the basis of parameters that indicate an operating state, such as art accelerator operation amount, a vehicle speed, and an engine rotational speed. For example, there is a method in which a primary pulley rotational speed is increased to an upper limit rotational speed at a rate of increase in engine rotational speed corresponding to a depression amount of an accelerator pedal, and, after that, the gear ratio is reduced to continuously increase the vehicle speed.

On the other hand, in the above control method for a CVT, because the primary pulley rotational speed is increased to an upper limit rotational speed without stopping, the maximum driving force of the engine may be used for acceleration, whereas, after the primary pulley rotational speed has been increased to the upper limit rotational speed, the engine rotational speed does not increase in contrast to an increase in vehicle speed. Thus, it is difficult to satisfy the acceleration feeling of the driver who wants to increase the vehicle speed with an increase in engine rotational speed. In response to the above problem, a shift control device for a CVT has been suggested, which controls the CVT so that a feeling of increase in engine rotational speed coincides with a feeling of increase in vehicle speed (for example, see Japanese Patent Application Publication No. 2004-125072 (JP-A-2004-125072)).

The above control device for a CVT controls the CVT to increase the vehicle speed by alternately repeating an acceleration gear ratio control and a rotational speed reduction control. In the acceleration gear ratio control, when the driver requires acceleration of the vehicle, the vehicle speed is increased in proportional to an increase in primary pulley rotational speed until the primary pulley rotational speed reaches an upper limit rotational speed. In the rotational speed reduction control, when the rotational speed reaches the upper limit rotational speed, the primary pulley rotational speed is reduced, while the gear ratio is changed.

With this configuration, the vehicle speed is increased with an increase in primary pulley rotational speed at the time of acceleration of the vehicle. Thus, it is possible to coincide a feeling of increase in engine rotational speed with a feeling of increase in vehicle speed and, as a result, a favorable acceleration feeling may be obtained. Furthermore, because the primary pulley rotational speed is reduced when the primary pulley rotational speed reaches the upper limit rotational speed, stagnation of engine rotational speed may be prevented.

Incidentally, the torque converter utilizes the flow of hydraulic oil to transmit power of the engine to the input shaft of the transmission mechanism. Specifically, the torque converter is formed so that a pump impeller, which serves as an input impeller, and a turbine runner, which servers as an output impeller, are accommodated in a doughnut-shaped housing (hereinafter, referred to as housing) filled with a viscous liquid, such as hydraulic fluid, and a stator, which serves as a slightly small impeller, is accommodated between the pump impeller and the turbine runner.

Then, the torque converter connects the output shaft of the engine to the pump impeller and connects the turbine runner to the input shaft of the transmission mechanism. By so doing, the torque converter transmits power of the engine to the transmission mechanism in such a manner that the pump impeller is rotated by the power of the engine to flow the hydraulic fluid and the stator controls a direction in which the hydraulic fluid flows to cause the hydraulic fluid to collide with the blades of the turbine runner for rotation.

Because of the above mechanism, the torque converter is not able to transmit 100 percent of input-side power to the output side when power of the engine is transmitted to the transmission mechanism by hydraulic oil, because of a friction or a slip between the hydraulic oil and the pump impeller and turbine runner, a transmission loss, and the like. Then, some torque converters include a lock-up mechanism that directly connects the input shaft with the output shaft, and equalizes the input rotational speed to the output rotational speed to thereby prevent an energy loss.

However, when the torque converter provided with the lock-up mechanism shifts from a lock-up released state into a lock-up engaged state, a transmission loss caused by hydraulic oil is eliminated, while the engine rotational speed is reduced so that the output rotational speed remains unchanged. Here, if an increase in engine rotational speed stagnates or decreases despite acceleration of the vehicle, the driver may feel it as poor drivability. Thus, a decrease in engine rotational speed when shifting into the lock-up engaged state as described above may problematically cause the driver to feel uncomfortable, particularly, during acceleration.

### SUMMARY OF THE INVENTION

The invention provides a control device and control method for a vehicle that are able to prevent driver's uncomfortable feeling due to a decrease in engine rotational speed at the time of lock-up engagement during acceleration.

A first aspect of the invention provides a control device for a vehicle that includes a torque converter that converts power, input from a power engine to an input shaft of the torque converter, into power, output from an output shaft of the torque converter, using flow of fluid, and has a lock-up mechanism that directly couples the input shaft with the output shaft on the basis of an operating state; and a transmission that is able to change a gear ratio between a rotational speed input from the torque converter and a rotational speed output from the transmission in a stepped manner. The control device includes a lock-up control unit that executes a lock-up control such that, when the gear ratio of the transmission decreases, the lock-up mechanism of the torque converter shifts from a released state into an engaged state. Note that the phrase that the gear ratio of an input shaft of the transmission to an output shaft of the transmission is decreasing means that shifting the vehicle into a higher gear to increase a vehicle speed, that is, so-called, upshift.

With the above configuration, when the gear ratio of the transmission decreases, that is, during shifting at the time when the vehicle speed increases, the lock-up mechanism of the torque converter shifts from a released state into an engaged state. Thus, it is possible to synchronize a decrease in engine rotational speed due to shifting with a decrease in engine rotational speed due to lock-up engagement. Hence, lock-up engagement may be performed so that the driver does not recognize a decrease in engine rotational speed due to the lock-up engagement and, as a result, it is possible to prevent driver's uncomfortable feeling.

In addition, the control device according to the above aspect may further include: a vehicle operating condition detecting unit that detects an operating condition of the vehicle; and an acceleration request determination unit that determines, on the basis of the operating condition of the vehicle, detected by the vehicle operating condition detecting unit, whether an acceleration request for the vehicle is issued, wherein when the acceleration request determination unit determines that the acceleration request for the vehicle is issued, the lock-up control unit may execute the lock-up control such that the lock-up mechanism shifts from the released state into the engaged state.

With the above configuration, particularly, when an acceleration request is issued, lock-up control is performed at the time of shifting gears. Thus, the driver does not feel a decrease in engine rotational speed during acceleration and, therefore, it is possible to prevent driver's uncomfortable feeling.

Moreover, in the control device according to the above aspect, the lock-up control unit may complete the lock-up control when the gear ratio of the transmission is being changed.

With the above configuration, because the lock-up control is completed when the gear ratio of the transmission is being changed, a decrease in engine rotational speed does not occur during running at a predetermined gear ratio and, therefore, it is possible to prevent driver's uncomfortable feeling.

Furthermore, the lock-up control unit may control a rate, at which the lock-up mechanism is engaged, so as to complete the lock-up control when the gear ratio of the transmission is being changed.

With the above configuration, lock-up engagement may be performed at an appropriate rate such that the lock-up control is completed when the gear ratio is being changed by the transmission. Thus, a decrease in engine rotational speed does not occur during running at a predetermined gear ratio and, therefore, it is possible to prevent driver's uncomfortable feeling.

The transmission may be a continuously variable transmission that is able to continuously change the gear ratio and that is also able to change the gear ratio in a stepped manner, and the lock-up control unit may execute the lock-up control when the gear ratio of the transmission is being changed in a stepped manner.

With the above configuration, even in a continuously variable transmission in which an increase in vehicle speed does not correspond to an increase in engine rotational speed in comparison with a stepped transmission, it is possible to execute a control such that an increase in engine rotational speed corresponds to an increase in vehicle speed. Thus, it is possible to prevent driver's uncomfortable feeling.

The lock-up control unit may set a period of time taken to change the gear ratio of the transmission in a stepped manner on the basis of a rate at which the transmission shifts gears and an amount by which the transmission shifts gears in a stepped manner.

With the above configuration, a period of time during which the gear ratio is changed in a stepped manner by the transmission is appropriately set. Thus, it is possible to set an appropriate period of time for lock-up engagement in association with the period of time taken to change the gear ratio in a stepped manner and, as a result, it is possible to prevent driver's uncomfortable feeling.

Another aspect of the invention provides a control method for a vehicle that includes a torque converter that converts power, input from a power engine to an input shaft of the torque converter, into power, output from an output shaft of the torque converter, using flow of fluid, and has a lock-up mechanism that directly couples the input shaft with the output shaft on the basis of an operating state; and a transmission that is able to change a gear ratio between a rotational speed input from the torque converter and a rotational speed output from the transmission in a stepped manner. The control method includes: determining whether an operating condition of the vehicle is indicating an acceleration request; when it is determined that the operating state is indicating the acceleration request, determining whether a control for decreasing the gear ratio of the transmission is executed, and when the gear ratio decreases, shifting the lock-up mechanism from a released state into an engaged state.

According to the aspects of the invention, it is possible to provide a control device and control method for a vehicle, which is able to synchronize a decrease in engine rotational speed due to shifting with a decrease in engine rotational speed due to lock-up engagement, perform lock-up engagement so that the driver does not recognize a decrease in engine rotational speed due to the lock-up engagement, and then prevent driver's uncomfortable feeling.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a schematic block diagram of a vehicle power transmission system with a continuously variable transmission according to an embodiment of the invention;

FIG. 2 is a view that shows portion of a hydraulic pressure control circuit that performs a belt tension control according to the embodiment of the invention;

FIG. 3 is a view that shows portion of the hydraulic pressure control circuit that performs a gear ratio control according to the embodiment of the invention;

FIG. 4 is a block diagram that shows an electronic control unit according to the embodiment of the invention;

FIG. 5 is a flowchart that shows a lock-up engagement process executed by the electronic control unit according to the embodiment of the invention;

FIG. 6 is a graph that shows a lock-up engagement reference area according to the embodiment of the invention; and

FIG. 7 is a timing chart that shows temporal changes in engine rotational speed, primary sheave rotational speed, torque converter slip rotational speed and engine torque in the lock-up engagement process executed by the electronic control unit according to the embodiment of the invention.

### DETAILED DESCRIPTION OF EMBODIMENTS

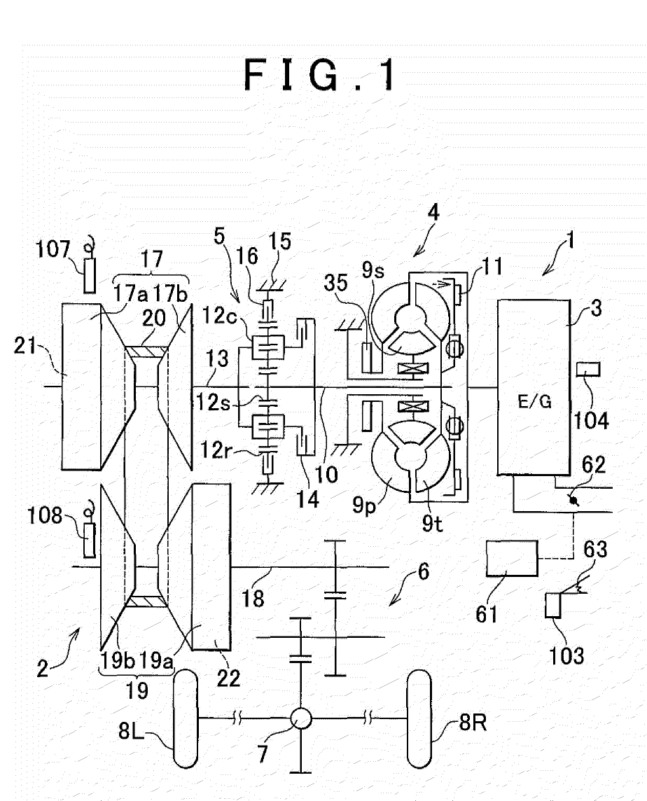

Hereinafter, an embodiment of the invention will be described with reference to the accompanying drawings. First, the configuration of the embodiment will be described. FIG. 1 is a schematic block diagram of a vehicle power transmission system with a continuously variable transmission according to the embodiment of the invention.

As shown in FIG. 1, a power transmission system 1 is, for example, applied to a transversely mounted front-engine front-drive (FF) vehicle, and includes a belt-type continuously variable transmission 2 and an engine 3, which is an internal combustion engine.

The output of the engine 3 is transmitted from a torque converter 4 through a forward-reverse switching device 5, the belt-type continuously variable transmission (hereinafter, simply referred to as “CVT”) 2 and a reduction gear 6 to a differential gear unit 7, and then distributed to left and right driving wheels 8L and 8R. That is, the CVT 2 is provided in a power transmission path from the engine 3 to the left and right driving wheels (for example, front wheels) 8L and 8R.

In addition, the torque converter 4 includes a pump impeller 9p coupled to a crankshaft of the engine 3, a turbine runner 9t coupled to the forward-reverse switching device 5 through a turbine shaft 10, and a stator 9s rotatably supported by a non-rotating member through a one-way clutch, and then the torque converter 4 transmits power via fluid.

In addition, a lock-up clutch (direct coupling clutch) 11 is provided between the pump impeller 9p and the turbine runner 9t. The lock-up clutch 11 couples the pump impeller 9p with the turbine runner 9t as one so that they can rotate integrally with each other.

The forward-reverse switching device 5 is formed of a double pinion type planetary gear set. The turbine shaft 10 of the torque converter 4 is coupled to a sun gear 12s, and an input shaft 13 of the CVT 2 is coupled to a carrier 12c.

Then, when a forward clutch 14 arranged between the carrier 12c and the sun gear 12s is engaged, the forward-reverse switching device 5 is integrally rotated, and the turbine shaft 10 is directly coupled to the input shaft 13. Thus, forward driving force is transmitted to the driving wheels 8L and 8R.

In addition, when a reverse brake 16 arranged between a ring gear 12r and a housing 15 is engaged and the forward clutch 14 is released, the input shaft 13 is rotated in a reverse direction with respect to the turbine shaft 10. Thus, reverse driving force is transmitted to the driving wheels 8L and 8R.

On the other hand, the CVT 2 includes a primary pulley 17, a secondary pulley 19, and a transmission belt 20. The primary pulley 17 is provided on the input shaft 13 and is variable in effective diameter. The secondary pulley 19 is provided on an output shaft 18 and is variable in effective diameter. The/transmission belt 20 is wound around V grooves formed respectively in the primary pulley 17 and the secondary pulley 19. Power is transmitted by frictional force between the transmission belt 20, which operates as a power transmission element, and the inner wall surfaces of the V grooves of the primary pulley 17 and secondary pulley 19.

Specifically, the primary pulley 17 has a movable sheave 17a and a fixed sheave 17b. The movable sheave 17a and the fixed sheave 17b face each other to form the V groove. The transmission belt 20 is wound around the V groove that is formed by the movable sheave 17a and the fixed sheave 17b.

In addition, the secondary pulley 19 has a movable sheave 19a and a fixed sheave 19b. The movable sheave 19a and the fixed sheave 19b face each other to form the V groove. The transmission belt 20 is wound around the V groove that is formed by the movable sheave 19a and the fixed sheave 19b.

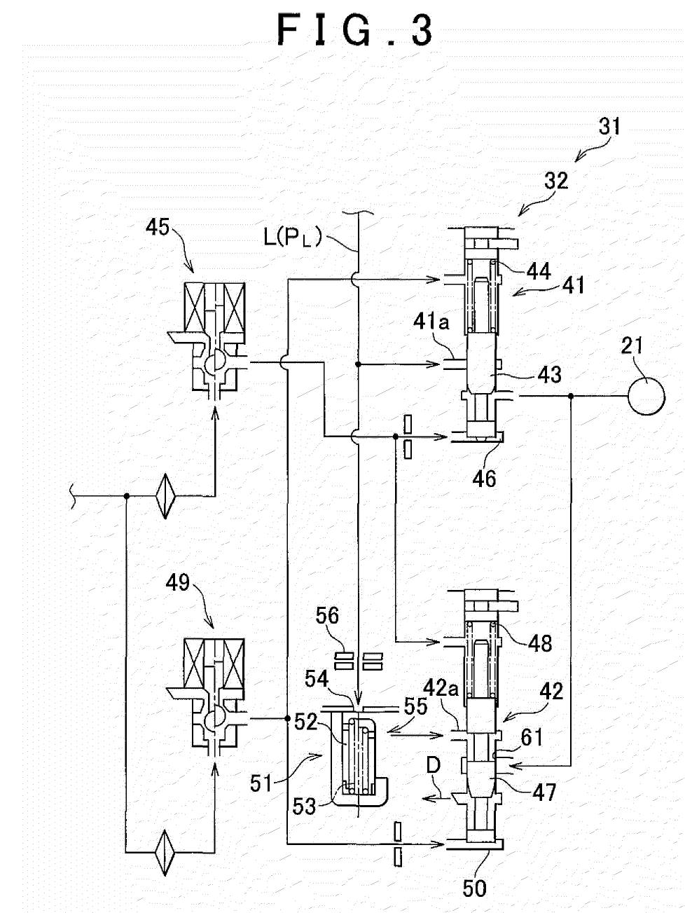

The primary pulley 17 has an input-side hydraulic cylinder 21 formed on the movable sheave 17a in order to change the V groove width, that is, the turning radius of the transmission belt 20. The secondary pulley 19 has an output-side hydraulic cylinder 22 formed on the movable sheave 19a in order to change the V groove, that is, the turning radius of the transmission belt 20. The flow of hydraulic oil supplied to or discharged from the input-side hydraulic cylinder 21 of the movable sheave 17a is controlled by a shift control valve device 32 (see FIG. 3) in a hydraulic pressure control circuit 31. Thus, the V groove width of the primary pulley 17 and the V groove width of the secondary pulley 19 are changed to vary the turning radii (effective diameters) of the transmission belt 20. By so doing, the gear ratio γ(=actual rotational speed N_{IN} of the input shaft 13 of the primary pulley 17/actual rotational speed N_{OUT} of the output shaft 18 of the secondary pulley 19) may be changed continuously, that is, steplessly.

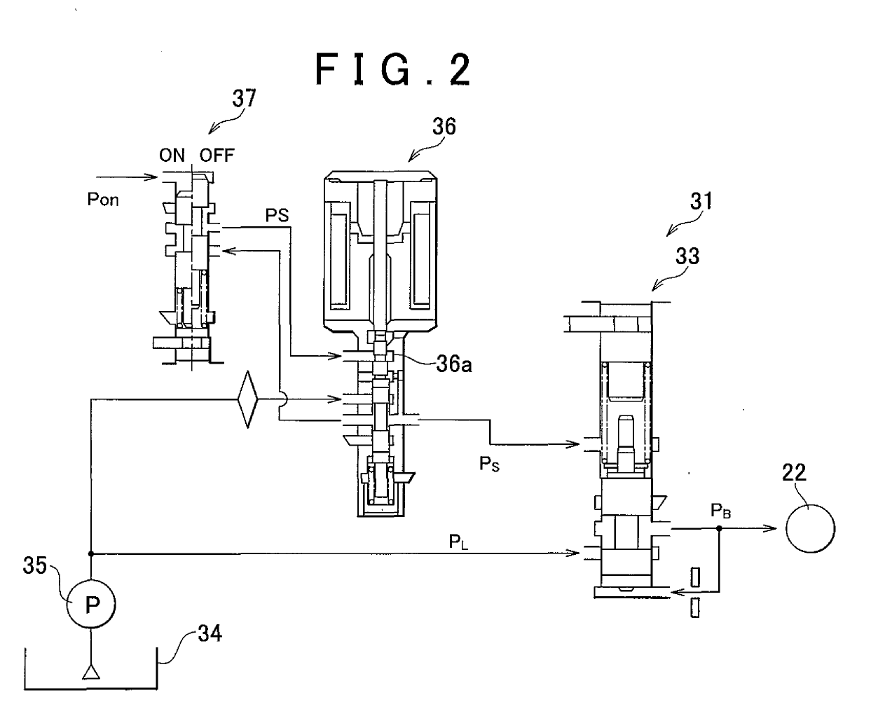

In addition, a hydraulic pressure P_{B} in the output-side hydraulic cylinder 22 of the movable sheave 19a corresponds to a clamping force applied to the transmission belt 20 of the secondary pulley 19 and a tension of the transmission belt 20, and is closely related to a tension of the transmission belt 20, that is, a pressing force of the transmission belt 20, applied to the V groove inner wall surfaces of the primary pulley 17 and secondary pulley 19. Thus, the hydraulic pressure P_{B} may be called a belt tension control pressure, a belt clamping force control pressure, or a belt pressing force control pressure. The hydraulic pressure P_{B} is regulated by a clamping force control valve 33 (see FIG. 2) in the hydraulic pressure control circuit 31 so that the transmission belt 20 does not slip.

FIG. 2 is a view that shows portion of the hydraulic pressure control circuit that performs a belt tension control according to the embodiment of the invention. In addition, FIG. 3 is a view that shows portion of the hydraulic pressure control circuit that performs a gear ratio control according to the embodiment of the invention.

As shown in FIG. 2, hydraulic oil returned to an oil tank 34 is fed under pressure by a hydraulic pump 35, regulated to a line pressure P_{L} by a line pressure regulating valve (not shown), and then supplied as a source pressure to a liner solenoid valve 36 and the clamping force control valve 33. Note that the hydraulic pump 35 is, for example, a gear hydraulic pump that is directly coupled to the engine 3 (see FIG. 1) and is driven by the engine 3 for rotation.

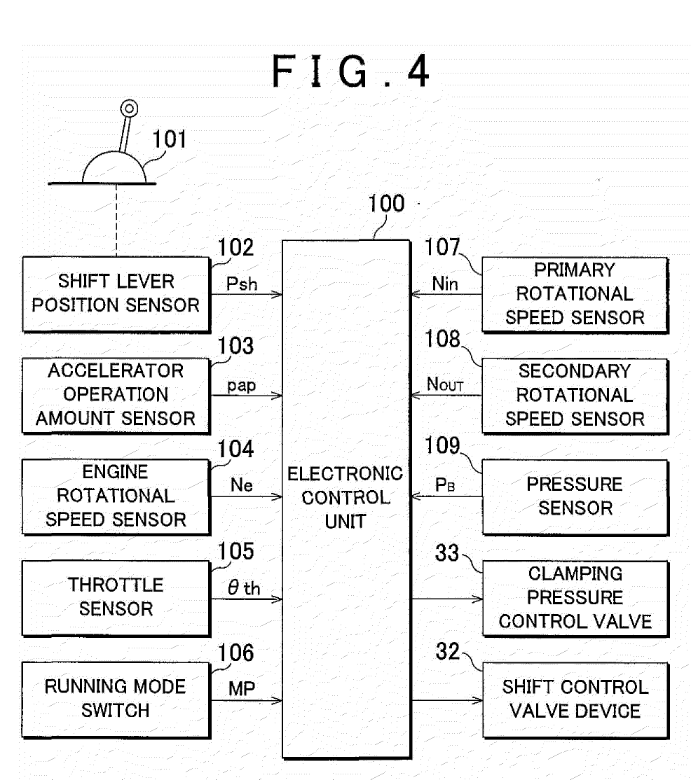

The liner solenoid valve 36 is continuously controlled by an exciting current output from the electronic control unit 100 (see FIG. 4) to generate a control pressure P_{S} with a magnitude corresponding to the exciting current from the hydraulic pressure of the hydraulic oil supplied from the hydraulic pump 35 and then supplies the control pressure P_{S} to the clamping force control valve 33.

The clamping force control valve 33 generates a hydraulic pressure P_{B} that increases with an increase in the control pressure P_{S} and then supplies the hydraulic pressure P_{B} to the output-side hydraulic cylinder 22 of the movable sheave 19a to thereby operate so as to reduce the clamping force applied to the transmission belt 20, that is, the tension of the transmission belt 20 as small as possible within the range in which the transmission belt 20 does not slip. In addition, the hydraulic pressure P_{B} increases the belt clamping force, that is, the factional force between both the primary pulley 17 and secondary pulley 19 and the transmission belt 20 with the increase in the hydraulic pressure P_{B}.

The liner solenoid valve 36 has an oil chamber 36a. The control pressure P_{S}, output from a cut-back valve 37 at the time when the cut-back valve 37 is on, is supplied to the oil chamber 36a, while, at the time when the cut-back valve 37 is off, the supply of the control pressure P_{S} to the oil chamber 36a of the liner solenoid valve 36 is shut off to open the oil chamber 36a to the atmosphere. Thus, the characteristic of the control pressure P_{S} is switched to a low pressure side when the cut-back valve 37 is on as compared to when the cut-back valve 37 is off.

In addition, the cut-back valve 37 is switched over to an on state by a signal pressure P_{ON} supplied from an electromagnetic valve (not shown) when the lock-up clutch 11 of the torque converter 4 is on (engaged).

As shown in FIG. 3, the shift control valve device 32 is formed of an upshift control valve 41 and a downshift control valve 42. The upshift control valve 41 supplies hydraulic oil of the line pressure P_{L} to the input-side hydraulic cylinder 21 of the movable sheave 17a, and controls the flow of the hydraulic oil to control the rate of upshift. The downshift control valve 42 controls the flow of hydraulic oil discharged from the input-side hydraulic cylinder 21 of the movable sheave 17a to control the rate of downshift.

The upshift control valve 41 has an input port 41a that communicates with a line oil passage L that introduces the line pressure P_{L,} a spool valve 43 that opens or closes a path between the line oil passage L and the input-side hydraulic cylinder 21, a spring 44 that urges the spool valve 43 in a valve closing direction, and a control oil chamber 46 that introduces a control pressure output from an upshift electromagnetic valve 45.

In addition, the downshift control valve 42 includes a spool valve 47 that opens or closes a path between a drain oil passage D and the input-side hydraulic cylinder 21, a spring 48 that urges the spool valve 47 in a valve closing direction, and a control oil chamber 50 that introduces a control pressure output from a downshift electromagnetic valve 49.

The upshift electromagnetic valve 45 and the downshift electromagnetic valve 49 are duty-driven by the electronic control unit 100 to supply a continuously varying control pressure to the control oil chamber 46 and the control oil chamber 50, thus continuously changing the gear ratio γ of the CVT 2 to upshift (reduce the gear ratio) or downshift (increase the gear ratio).

In addition, a pressure regulating valve 51 is connected to the input port 42a of the downshift control valve 42. The pressure regulating valve 51 is formed of a valve that has an input port 54 on one side of a piston 52 pressed by a spring 53 and an output port 55 that communicates with both the one side and the other side of the piston 52. The input port 54 is supplied with the line pressure P_{L}. The output port 55 communicates with the input port 42a of the downshift control valve 42.

In addition, the input port 54 is supplied with the line pressure P_{L} through a double orifice 56 having a small opening area. That is, the pressure regulating valve 51 regulates the line pressure P_{L} to a hydraulic pressure that is obtained by subtracting an elastic force of the spring 53 from the line pressure P_{L,} and the regulated line pressure P_{L} is generated at the output port 55, that is, the input port 42a of the downshift control valve 42.

FIG. 4 is a block diagram that shows the electronic control unit according to the embodiment of the invention. As shown in FIG. 4, the electronic control unit 100 is connected to a shift lever position sensor 102, an accelerator operation amount sensor 103, an engine rotational speed sensor 104, a throttle sensor 105, a running mode switch 106, a primary rotational speed sensor 107, a secondary rotational speed sensor 108, a pressure sensor 109, the clamping force control valve 33 and the shift control valve device 32.

The shift lever position sensor 102 detects an operating position Psh of a shift lever 101 provided in a compartment of the vehicle, and outputs a signal, corresponding to the detected operating position Psh, to the electronic control unit 100.

Here, the shift lever 101 is manually operated to four lever positions “P”, “R”, “N”, or “D-S”. The “P” position is a park position in which rotation of the output shaft 18 is locked. The “R” position is a reverse running position in which the output shaft 18 is rotated in a reverse direction. The “N” position is a power transmission interruption position in which the power transmission path from the engine 3 to the left and right driving wheels 8L and 8R is disconnected. The “D-S” position is a forward running position in which the gear ratio is automatically set on the basis of the running state of the vehicle to perform normal running.

The accelerator operation amount sensor 103 detects an operation amount pap of an accelerator pedal 63 (see FIG. 1) (hereinafter, simply referred to as “accelerator operation amount”), and outputs a signal, corresponding to the detected accelerator operation amount pap, to the electronic control unit 100.

The engine rotational speed sensor 104 detects a rotational speed Ne of the engine 3 (hereinafter, simply referred to as “engine rotational speed”), and outputs a signal, corresponding to the detected engine rotational speed Ne, to the electronic control unit 100. Note that the engine rotational speed sensor 104 detects a rotational speed of the crankshaft of the engine 3.

The throttle sensor 105 detects an opening degree θth of the throttle valve 62 (see FIG. 1) (hereinafter, simply referred to as “throttle opening degree”) driven by a throttle actuator 61, and outputs a signal, corresponding to the detected throttle opening degree θth, to the electronic control unit 100.

The running mode switch 106 detects an operation of a button, or the like, by the driver when the lever position is at the “D-S” position, and outputs a mode selection signal, by which the running mode is set to a fuel economy-conscious normal running mode or an acceleration-conscious sporty running mode, to the electronic control unit 100.

The primary rotational speed sensor 107 detects an actual rotational speed N_{IN} of the input shaft 13 of the primary pulley 17 (hereinafter, simply referred to as “input rotational speed”), and outputs a signal, corresponding to the detected input rotational speed NIN, to the electronic control unit 100. Note that the input rotational speed N_{IN} is equal to the rotational speed of the turbine shaft 10, which is the output rotational speed of the torque converter 4.

The secondary rotational speed sensor 108 detects a rotational speed N_{OUT} of the output shaft 18 of the secondary pulley 19 (hereinafter, simply referred to as “output rotational speed”), and outputs a signal, corresponding to the detected output rotational speed N_{OUT}, to the electronic control unit 100. Here, the electronic control unit 100 calculates a vehicle speed V on the basis of the output rotational speed N_{OUT} detected by the secondary rotational speed sensor 108.

The pressure sensor 109 detects an internal pressure of the output-side hydraulic cylinder 22 of the movable sheave 19a, that is, an actual belt clamping force control pressure P_{B;} and outputs a signal, corresponding to the detected belt clamping force control pressure P_{B,} to the electronic control unit 100.

The electronic control unit 100 is formed of a microcomputer that includes a central processing unit (CPU), a read only memory (ROM), a random access memory (RAM), an input interface, an output interface, and the like. The electronic control unit 100 utilizes the temporary storage function of the RAM while processing signals in accordance with a shift control program that is pre-stored in the ROM, thus executing a shift control over the CVT 2 so as to obtain favorable acceleration feeling and fuel economy.

Hereinafter, the characteristic configuration of the electronic control unit 100 that constitutes the control device for a continuously variable transmission according to the embodiment of the invention will be described.

The electronic control unit 100 executes a control such that, when the gear ratio of the input shaft 13 of the CVT 2 to the output shaft 18 of the CVT 2 decreases, the lock-up clutch 11 of the torque converter 4 shifts from a released state into an engaged state. In addition, the electronic control unit 100 shifts the lock-up clutch 11 from the released state into the engaged state when an acceleration request is issued.

In addition, the electronic control unit 100 executes a control such that, when the gear ratio of the CVT 2 is being changed, engagement of the lock-up clutch 11 is completed. In addition, the electronic control unit 100 controls the rate, at which the lock-up clutch 11 is engaged, so that engagement of the lock-up clutch 111 is completed when the gear ratio of the CVT 2 is being changed.

In addition, the CVT 2 is a continuously variable transmission that is able to continuously change the gear ratio and is also able to change the gear ratio in a stepped manner (step change), and the electronic control unit 100 engages the lock-up clutch 11 when the gear ratio of the CVT 2 is changed in a stepped manner. In addition, the electronic control unit 100 sets a period of time that is taken to change the gear ratio of the CVT 2 in a stepped manner, on the basis of a rate at which the CVT 2 shifts gears and an amount by which the CVT 2 shifts gears in a stepped manner. That is, the electronic control unit 100 may constitute a lock-up control unit according to the aspects of the invention.

Furthermore, the electronic control unit 100 detects an operating condition of the vehicle. In the present embodiment, the electronic control unit 100 detects an operating condition of the vehicle on the basis of the signal corresponding to the operating position Psh of the shift lever 101, detected by the shift lever position sensor 102, the signal corresponding to the accelerator operation amount pap detected by the accelerator operation amount sensor 103, the signal corresponding to the engine rotational speed Ne detected by the engine rotational speed sensor 104, the signal corresponding to the throttle opening degree θth detected by the throttle sensor 105, the mode selection signal input from the running mode switch 106, and the like. That is, the electronic control unit 100 may constitute a vehicle operating condition detecting unit according to the aspects of the invention.

In addition, the electronic control unit 100 determines, on the basis of the detected operating condition of the vehicle, whether an acceleration request for the vehicle is issued. That is, the electronic control unit 100 may constitute an acceleration request determination unit according to the aspects of the invention.

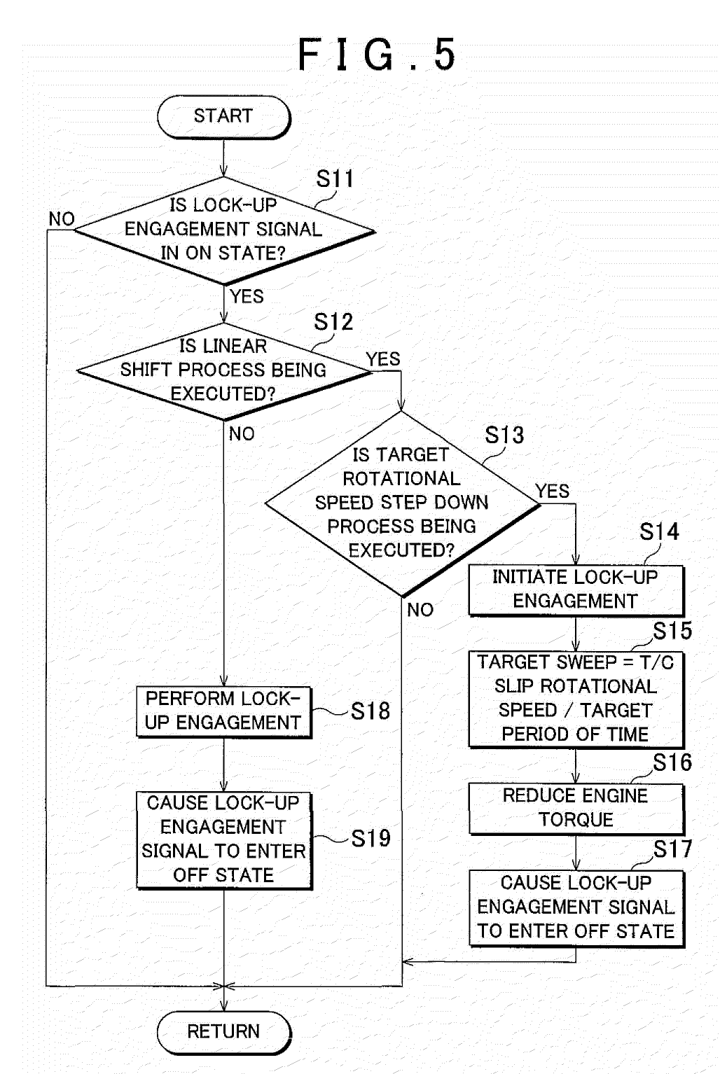

Next, the operation will be described. FIG. 5 is a flowchart that shows a lock-up engagement process executed by the electronic control unit according to the embodiment of the invention.

Note that the flowchart shown in FIG. 5 is a program of the lock-up engagement process executed by the CPU of the electronic control unit 100, and the program of the lock-up engagement process is stored in the ROM. In addition, the lock-up engagement process is executed by the CPU of the electronic control unit 100 at predetermined time intervals.

Note that the lock-up engagement process may be configured so that the process is executed when a lock-up engagement signal, which will be described later, enters an on state, instead of determining the on/off state of the lock-up engagement signal (step S11). In this case, when lock-up engagement is not performed in this process, the lock-up engagement process is executed again at a predetermined timing. Alternatively, the lock-up engagement process is executed at a timing at which the gear is shifted.

As shown in FIG. 5, first, the electronic control unit 100 determines whether the lock-up engagement signal is in the on state (step S11). For example, the electronic control unit 100 pre-stores a lock-up engagement reference area, which is determined on the basis of a vehicle speed and an accelerator operation amount, in the ROM, and, when the relationship between the vehicle speed V and the accelerator operation amount pap falls within the lock-up engagement reference area, causes the lock-up engagement signal to enter an on state. Then, when the lock-up engagement signal is in the on state, it is determined that lock-up engagement is required, whereas, when the lock-up engagement signal is in the off state, it is determined that lock-up engagement is not required.

Specifically, the lock-up engagement reference area indicates the relationship between the vehicle speed V and the accelerator operation amount pap, in which lock-up engagement is required. Thus, when the relationship between the vehicle speed V and the accelerator operation amount pap falls within the lock-up engagement reference area, it indicates a running state that requires lock-up engagement. Then, the electronic control unit 100 outputs the lock-up engagement signal to cause lock-up engagement of the torque converter.

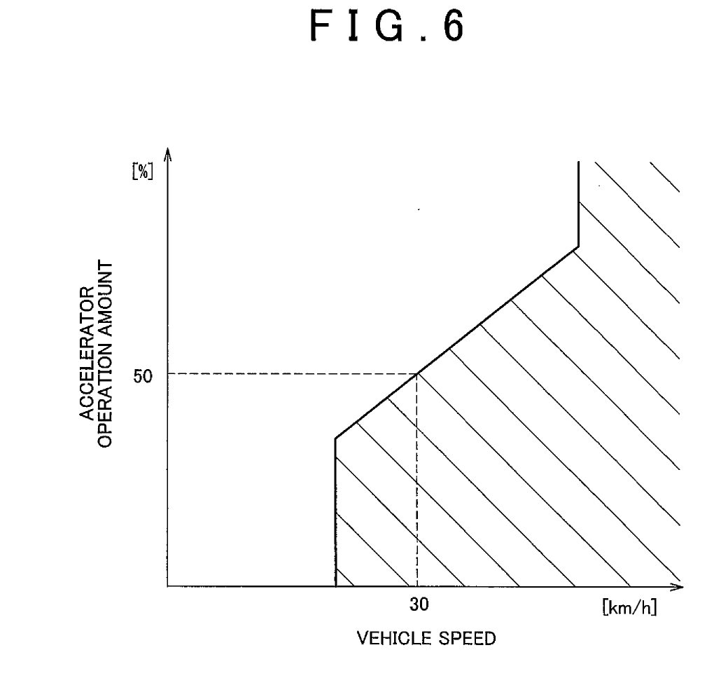

FIG. 6 is an example of a graph that shows the lock-up engagement reference area according to the embodiment of the invention. The hatched area shown in FIG. 6 indicates the lock-up engagement reference area. As shown in FIG. 6, when the accelerator operation amount pap is 50% and the vehicle speed V is lower than 30 km/h, the running state does not fall within the lock-up engagement reference area. On the other hand, even when the accelerator operation amount pap is the same 50%, when the vehicle speed V is higher than or equal to 30 km/h, the running state falls within the lock-up engagement reference area.

Note that the lock-up engagement reference area may be changed on the basis of the number of steps of the transmission (gear ratios of the transmission). In addition, the lock-up engagement reference area is determined on the basis of the vehicle speed V and the accelerator operation amount pap. Instead, the lock-up engagement reference area may be simply determined only on the basis of the vehicle speed.

When the electronic control unit 100 determines that the lock-up engagement signal is not in the on state (NO in step S11), the electronic control unit 100 ends the lock-up engagement process. On the other hand, when the electronic control unit 100 determines that the lock-up engagement signal is in the on state (YES in step S11), the electronic control unit 100 determines whether a linear shift process is being executed (step S12).

Here, the linear shift will be described. The CVT 2 is able to continuously increase the vehicle speed in such a manner that, when an acceleration request is issued, the primary pulley rotational speed is increased to an upper limit rotational speed at a rate of increase in engine rotational speed corresponding to a depression amount of the accelerator pedal and, after that, the gear ratio is continuously decreased. However, in the above control, the vehicle speed is increased so that the primary pulley rotational speed is increased to the upper limit rotational speed and then the gear ratio is continuously decreased, so that the engine rotational speed does not increase in contrast to an increase in vehicle speed. Thus, it is difficult to satisfy the acceleration feeling of the driver who wants to increase the vehicle speed with an increase in engine rotational speed.

Then, when an acceleration of the vehicle is required by the driver, until the rotational speed of the primary pulley 17 is increased by a predetermined amount of increase in rotational speed on the basis of an operating condition, the vehicle speed is increased by alternately repeating an acceleration gear ratio control in which the vehicle speed is increased in proportion to an increase in rotational speed of the primary pulley 17 and a rotational speed reduction control in which the rotational speed of the primary pulley 17 is decreased to change the gear ratio. In the specification, the above control is called linear shift.

Through the above linear shift process, a feeling of increase in engine rotational speed coincides with a feeling of increase in vehicle speed, and it is possible to satisfy the acceleration feeling of the driver who wants to increase the vehicle speed with an increase in engine rotational speed. The electronic control unit 100 determines, on the basis of the operating condition, whether the linear shift process is executed, and, where necessary, executes the linear shift process.

When the electronic control unit 100 determines that the linear shift process is being executed (YES in step S12), the electronic control unit 100 proceeds to step S13. On the other hand, when the electronic control unit 100 determines that the linear shift process is not being executed (NO in step S12), the electronic control unit 100 proceeds to step S18.

When the electronic control unit 100 determines that the linear shift process is being executed (YES in step S12), the electronic control unit 100 determines whether a target rotational speed step down process is being executed (step S13). The target rotational speed step down process reduces the primary pulley rotational speed to decrease the gear step (decrease the gear ratio to upshift).

When the electronic control unit 100 determines that the target rotational speed step down process is not being executed (NO in step S13), the electronic control unit 100 ends the lock-up engagement process. Thus, when no shift control is performed, lock-up engagement is not performed.

On the other hand, when the electronic control unit 100 determines that the target rotational speed step down process is being executed (YES in step S13), the electronic control unit 100 proceeds to step S14.

When the electronic control unit 100 determines that the target rotational speed step down process is being executed (YES in step S13), the electronic control unit 100 initiates lock-up engagement (step S14). Next, the electronic control unit 100 calculates a target sweep (step S15). The target sweep is a target rate of engagement when lock-up engagement of the torque converter 4 is performed. The target sweep is calculated by the following expression.

(Target sweep)=(T/C slip rotational speed)/(Target period of time)

Here, the T/C slip rotational speed represents a difference between the rotational speed of the input shaft of the torque converter 4 (equal to the rotational speed of the engine 3) and the rotational speed of the output shaft of the torque converter 4 (rotational speed of the turbine shaft 10), and the target period of time represents a target period of time that is taken until lock-up engagement is complete.

In addition, at this time, the target period of time is calculated on the basis of a shifting period of time that of the CVT 2. Here, the target period of time is equalized to the shifting period of time so that a time at which the shifting process ends coincides with a time at which the lock-up engagement is complete. The shifting period of time is calculated by the following expression.

(Shifting period of time)=(Amount of step for shifting)/(Rate of shifting)

Here, the amount of step for shifting represents the amount by which the CVT 2 shifts gears, and the rate of shifting represents the amount by which the CVT 2 shifts gears per unit time, that is, the rate at which the CVT 2 shifts gears. For example, the amount of step for shifting represents a distance by which the transmission belt 20 moves on the movable sheave 17a of the CVT 2 through the shifting, and the rate of shifting represents the rate at which the transmission belt 20 is moved on the movable sheave 17a. Through the above, it is possible to calculate a time taken to shift gears, that is, a shifting period of time.

Next, the electronic control unit 100 reduces the torque of the engine 3 (step S16). Here, the electronic control unit 100 executes a control such that the torque is reduced together with initiation of lock-up engagement and the torque is returned together with completion of the lock-up engagement. This torque reduction is able to prevent shock due to inertia at the time of lock-up engagement.

Next, the electronic control unit 100 causes the lock-up engagement signal to enter an off state (step S17) to end the lock-up engagement process.

On the other hand, when the electronic control unit 100 determines that the linear shift process is not being executed (NO in step S12), the electronic control unit 100 performs the lock-up engagement process for the torque converter 4 (step S18). Next, the electronic control unit 100 causes the lock-up engagement signal to enter an off state (step S19) to end the lock-up engagement process.

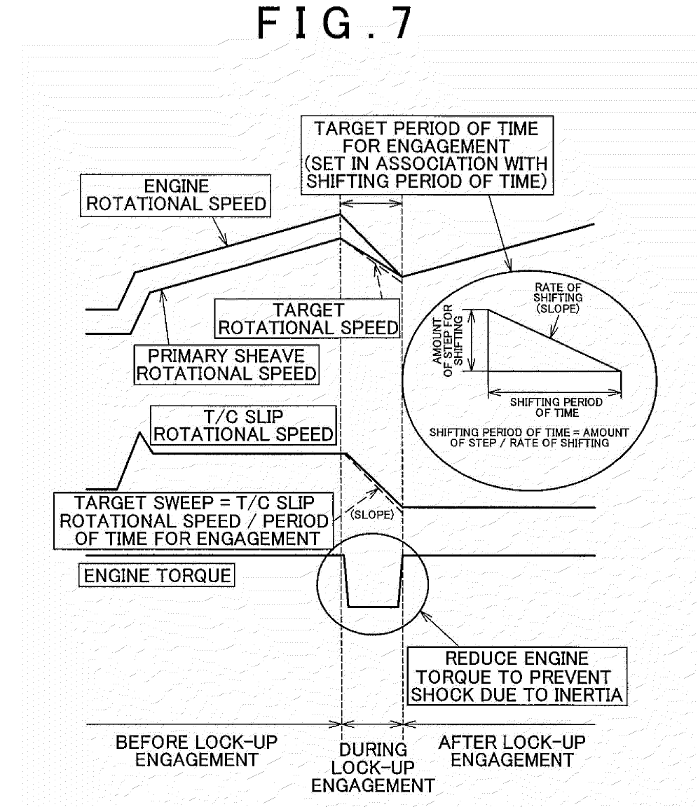

FIG. 7 is a timing chart that shows temporal changes in engine rotational speedy primary sheave rotational speed, torque converter slip rotational speed and engine torque in the lock-up engagement process executed by the electronic control unit according to the embodiment of the invention.

As shown in FIG. 7, before lock-up engagement, there is a difference between the input shaft rotational speed and output shaft rotational speed of the torque converter 4 (torque converter slip rotational speed). Thus, there occurs a difference between the engine rotational speed and the primary sheave rotational speed. Here, when the lock-up engagement process is performed, the input shaft of the torque converter 4 is directly coupled to the output shaft of the torque converter 4, and then there is no difference between the input shaft rotational speed and output shaft rotational speed of the torque converter 4. Thus, the engine rotational speed is equal to the primary sheave rotational speed.

In addition, the target sweep, which is the target rate of engagement at the time when lock-up engagement of the torque converter 4 is performed, is set so that the lock-up engagement process ends when the shifting process is being executed. That is, the shifting period of time is calculated on the basis of the amount of step for shifting and the rate of shifting in the CVT 2, a period of time that is taken for lock-up engagement of the torque converter 4 is set on the basis of the shifting period of time, and then the target sweep is set on the basis of the slip rotational speed of the torque converter 4 and the set period of time that is taken for lock-up engagement.

Furthermore, at the time of the lock-up engagement, the engine torque is reduced. This reduction in engine torque is able to prevent shock due to inertia.

As described above, the control device for a vehicle according to the present embodiment performs the lock-up engagement process for the torque converter 4 during a shifting process at the time when the vehicle speed increases. Thus, it is possible to synchronize a decrease in engine rotational speed due to shifting with a decrease in engine rotational speed due to lock-up engagement. Hence, lock-up engagement may be performed so that the driver does not recognize a decrease in engine rotational speed due to the lock-up engagement and, as a result, it is possible to prevent driver's uncomfortable feeling. Particularly, when an acceleration request is issued, the lock-up control is performed at the time of shifting gears. Thus, the driver does not feel a decrease in engine rotational speed during acceleration and, therefore, it is possible to prevent driver's uncomfortable feeling.

In addition, lock-up engagement may be performed at an appropriate rate such that the lock-up control is completed when the gear ratio is being changed by the transmission. Thus, a decrease in engine rotational speed does not occur during running at a constant gear ratio and, therefore, it is possible to prevent driver's uncomfortable feeling.

In addition, even in a continuously variable transmission in which an increase in vehicle speed does not correspond to an increase in engine rotational speed in comparison with a stepped transmission, a period of time during which the transmission shifts gears is appropriately set. Thus, it is possible to set an appropriate period of time for lock-up engagement in association with the period of time during which the transmission shifts gears and, as a result, it is possible to prevent driver's uncomfortable feeling.

As described above, the control device for a vehicle according to the aspects of the invention performs a lock-up control at the time of an increase in vehicle speed at the time of shifting gears. Thus, the control device is advantageous in that it is possible to synchronize a decrease in engine rotational speed due to shifting with a decrease in engine rotational speed due to lock-up engagement, lock-up engagement may be performed so that the driver does not recognize a decrease in engine rotational speed due to the lock-up engagement and, as a result, it is possible to prevent driver's uncomfortable feeling. Thus, it is useful in a control device, or the like, which controls a vehicle equipped with a lock-up torque converter and a transmission.

What is claimed is:

1. A control device for a vehicle comprising:
a torque converter that converts power, input from a power engine to an input shaft of the torque converter, into power, output from an output shaft of the torque converter, using flow of fluid, and has a lock-up mechanism that directly couples the input shaft with the output shaft on the basis of an operating state;
a transmission that is able to change a gear ratio between a rotational speed input from the torque converter and a rotational speed output from the transmission in a stepped manner; and
a lock-up control unit that executes a lock-up control such that, when the gear ratio of the transmission decreases, the lock-up mechanism of the torque converter shifts from a released state into an engaged state.

2. The control device according to claim 1, further comprising:
a vehicle operating condition detecting unit that detects an operating condition of the vehicle; and
an acceleration request determination unit that determines, on the basis of the operating condition of the vehicle, detected by the vehicle operating condition detecting unit, whether an acceleration request for the vehicle is issued, wherein
when the acceleration request determination unit determines that the acceleration request for the vehicle is issued, the lock-up control unit executes the lock-up control such that the lock-up mechanism shifts from the released state into the engaged state.

3. The control device according to claim 1, wherein the lock-up control unit completes the lock-up control when the gear ratio of the transmission is being changed.

4. The control device according to claim 2, wherein the lock-up control unit completes the lock-up control when the gear ratio of the transmission is being changed.

5. The control device according to claim 3, wherein the lock-up control unit controls a rate, at which the lock-up mechanism is engaged, so as to complete the lock-up control when the gear ratio of the transmission is being changed.

6. The control device according to claim 4, wherein the lock-up control unit controls a rate, at which the lock-up mechanism is engaged, so as to complete the lock-up control when the gear ratio of the transmission is being changed.

7. The control device according to claim 1, wherein the transmission is a continuously variable transmission that is able to continuously change the gear ratio and that is also able to change the gear ratio in a stepped manner, and wherein the lock-up control unit executes the lock-up control when the gear ratio of the transmission is being changed in a stepped manner.

8. The control device according to claim 7, wherein the lock-up control unit sets a period of time taken to change the gear ratio of the transmission in a stepped manner on the basis of a rate at which the transmission shifts gears and an amount by which the transmission shifts gears in a stepped manner.

9. The control device according to claim 7, wherein the continuously variable transmission includes a primary pulley that is coupled to the torque converter and a secondary pulley that is coupled to driving wheels, wherein
the control device executes a linear shift process over the continuously variable transmission, in which the linear shift process includes an acceleration gear ratio control in which a rotational speed of the primary pulley is increased to proportionally increase a vehicle speed and a rotational speed reduction control in which a rotational speed of the primary pulley is reduced while the gear ratio is changed, and wherein
the lock-up control unit executes the lock-up control when the rotational speed reduction control is being executed.

10. The control device according to claim 9, wherein
in the linear shift process, the acceleration gear ratio control and the rotational speed reduction control are alternately executed, and wherein
the lock-up control unit executes the lock-up control when the rotational speed reduction control is being executed.

11. A control method for a vehicle that includes a torque converter that converts power, input from a power engine to an input shaft of the torque converter, into power, output from an output shaft of the torque converter, using flow of fluid, and has a lock-up mechanism that directly couples the input shaft with the output shaft on the basis of an operating state; and a transmission that is able to change a gear ratio between a rotational speed input from the torque converter and a rotational speed output from the transmission in a stepped manner, the control method comprising:
determining whether an operating condition of the vehicle indicates ah acceleration request;
when it is determined that the operating condition/indicates the acceleration request, determining whether a control for decreasing the gear ratio of the transmission is executed, and
when the gear ratio decreases, shifting the lock-up mechanism from a released state into an engaged state.
